(19) United States
(12) Patent Application Publication
(10) Pub. No.: US 2015/0183211 A1
(43) Pub. Date: Jul. 2, 2015

(54) Method and Apparatus For Printing Cans

(71) Applicant: Rexam Beverage Can South America S.A., Rio De Janeiro (BR)

(72) Inventors: Michael A. Petti, Buffalo Grove, IL (US); Michael R. Gogola, Itasca, IL (US); Jonathan P. Meyer, Chicago, IL (US); David Stone, Chicago, IL (US); Timothy Wenckus, Homewood, IL (US)

(73) Assignee: Rexam Beverage Can South America S.A., Rio De Janeiro (BR)

(21) Appl. No.: 14/145,045

(22) Filed: Dec. 31, 2013

(51) Int. Cl. B41F 17/14

(52) U.S. Cl. CPC B41F 17/14

(57) ABSTRACT

A dry offset rotary metal beverage container decorator has a plurality of ink applicators, a plurality of printing plates, and a plurality of transfer blankets. Each printing plate has print surface engaging a corresponding ink applicator of the plurality of ink applicators and receives a quantity of fluid therefrom. Each transfer blanket has an ink receiving surface. Each ink receiving surface sequentially engages each print surface of the plurality of printing plates. The ink receiving surface has a plurality of blanket relief features of a photosensitive emulsion surface.

### TECHNICAL FIELD

The present invention relates to an apparatus for printing cans, especially aluminum cans having more than one finished art on its surface. The invention also relates to a process for printing the respective can, as well as to the can obtained by this printing process.

### BACKGROUND OF THE INVENTION

Modern metal beverage containers have printed designs and words on their exposed cylindrical sidewall. The words and designs generally consist of trademarks, trade dress, nutritional information, volume, and any other information that the metal beverage container manufacturer and the beverage manufacturers may want to communicate to consumers, competitors and others.

The most common printing type performed on metal beverage containers is the dry rotary offset-type which is made by a specific printer for this purpose. This type of printing enables one to apply a plurality of colors onto metallic metal beverage containers. Such printing is carried out on metal beverage container bodies during their manufacturing process. This process includes a sequence of cutting, cup forming, drawing and ironing, the printing itself and subsequent necking of the open end until the metal beverage container body reaches its final desired shape. The metal beverage container body is then filled with a beverage and a can lid is attached to the open end of the filled can body.

To better understand the field of the present invention, a prior art printing apparatus or a printer, as it is usually known, is illustrated in FIG. 1.

The apparatus 1 of FIG. 1 includes a plurality of components, wherein six ink cartridges 2a-2f are present. These cartridges 2a-2f are supplied with colored ink that is applied onto a cylindrical side wall of the metal beverage container body. The printing apparatus 1 is provided with an ink cartridge 2a-2f for each color that one wishes to apply onto the metal beverage container body. For example, if it is desired to print a metal beverage container with three colors, three of the six ink-cartridge 2a-2f should be supplied with the necessary corresponding colored ink. It should be noted that in this type of equipment, there is a limitation on the number of colors which can be applied to the metal beverage container that is dependent on the number of ink-cartridges available. In other words, if ten different colors are desired, it is necessary that the printing apparatus should have at least ten ink-cartridges 2a-2f.

The ink cartridges 2a-2f supply ink to printing plates 3a-3f, which have the finished art to be printed onto the metal beverage container. This finished art may be a text, a figure or any type of graphic which one wishes to make on a metal beverage container. Thus, it is very important to position the printing plate correctly relative to the metal beverage container and the ink cartridges 2a-2f. For this purpose, a printing plate, for example, 3a, which is generally produced from a magnetic material, has a precise alignment on a plate cylinder 4a.

This alignment or registration is achieved via guide-bores in the printing plate (not shown in the figure), which are aligned to guide-pins on the plate cylinder 4a. The plate cylinder is a substantially cylindrical body to which the printing plate is attached and rotates therewith. This is made possible as the outer surface of the plate cylinder is formed by a magnetic material that attracts the printing plate 3a and keeps it in the desired position.

It is also important to point out that the finished art present on the printing plate 4a is in relief, so that it transfers the ink supplied by the ink cartridge 2a to a transfer blanket 5a. This transfer blanket 5a is an ink transferring means between the printing plate 3a and the metal beverage container to be printed.

Thus, the relief on the printing plate 3a comes into contact with the transfer blanket 5a, transferring only the ink that is present thereon to the transfer blanket 5a. This is carried out by rotation of the printing plate 3a, which transfers the ink present in relief to the transfer blanket 5a, which is fixed on the transfer blanket drum 6, which has a rotation synchronized with (i) the metal beverage container bodies to be printed, (ii) the positioning of the transfer blankets 5a-5l that are on the surface of such a transfer blanket drum 6, and (iii) the printing plates 3a-3f.

The synchronization between aforementioned elements makes it possible to decorate the metal beverage container bodies in a quite precise manner. This is of the utmost importance in metal beverage container printing. There should be no overlapping of the print on the metal beverage container when it receives more than one finished art on its surface. In other words, the finished art of a first printing plate 3a will transfer ink only to a predetermined area of the transfer blankets 5a-5l, whereby a second printing plate 3b-3f will transfer ink only on its surface to another area on the transfer blankets 5a-5l that did not receive ink from the first printing plate 3a, and so on. This is dependent on the number of printing colors on the metal beverage containers.

Thus, printing of an entire metal beverage container cylindrical surface without ink overlapping is possible using this type of rotary dry offset printing apparatus.

In this regard, it should be stressed that there is transfer of more than one finished art with a different color to one or more than one transfer blanket 5a-5l present on the transfer blanket drum 6 from the respective printing plates 3a-3f that are in communication with the respective ink-cartridges. Hence, upon continuous rotation of the transfer blanket drum, the blanket comes into contact with the metal beverage container cylindrical surface to be printed. Thus, each blanket fully decorates one metal beverage container body upon rotaion of the drum.

It should be understood that each of the transfer blankets 5a-5l can receive, on its surface, a plurality of different colors coming from more than one printing plate 3a-3f, but the transfer blankets 5a-5l do not have any overlapping of finished art with different colors.

The metal beverage containers to be printed may be colorful, but when they are examined in detail, one can see that with this type of printing, there is no color overlapping. Despite the proximity of the different colors that are on the metal beverage container surface, there will always be a small space between the printing of different colors.

It is also important to note that, when one wishes to change the finished art present on the metal beverage containers that are being printed, it is necessary to interrupt the production, that is, the printing apparatus 1 would be necessarily stopped. Thus, production of metal beverage containers must be stopped. Such stoppage is necessary because there may be the need to change the printing color of the metal beverage container, or to change one product of metal beverage container to a different metal beverage container product. For example, when one is carrying out a type of metal beverage container printing for Product A and wishes to begin printing metal beverage containers for Product B, the finished art will also change, and it is necessary to interrupt the printing process. In short, with the existing process and equipment, it is only possible to achieve one type of finished art printed on the metal beverage container with the same printing apparatus. If it is necessary or desired to change the print on the metal beverage container, the production will necessarily have to be interrupted, which for economic reasons should be minimized as much as possible.

This can be easily observed through the order or magnitude of metal beverage container printing, which is very significant. With the present-day pieces of equipment, one can print approximately 2.5 million metal beverage containers in a single day.

Thus, at present, there are a number of studies with a view to minimize, as far as possible, the stoppages of this type of equipment, so that the production will not be interrupted. It is noted that these stoppages are, as a rule, necessary, because the same production line is intended for cans with the most varied finished arts. For example, metal beverage containers intended for beer and metal beverage container intended for soft drinks are produced on the same printing machine.

In turn, in the face of the significant amount of production of metal beverage containers and the substantial printing speed, the metal beverage containers that have been printed are packed for delivery to beverage manufacturers. Then, as an example, when there is production of a given type of metal beverage container, the produced metal beverage containers are packed on pallets, wherein each of the pallets have about 6,000-15,000 units of printed metal beverage containers, all having identical print designs, that is, with the same finished art printed on them.

Thus, the metal beverage container manufacturers' customers, mainly companies that produce beverages, receive loadings of these pallets. The beverage companies fill the metal beverage containers with beverages and deliver them to wholesalers and retailers, as for example, super-markets. In other words, the supermarkets will also receive a large number of cans with beverages having the same finished art printed thereon.

FIG. 2 shows the size of a standard-pallet containing about 8,500 metal beverage containers. As one can see in this figure, there is a man of medium height beside the pallet that contains the metal beverage containers. From this, it is possible to have a quite significant idea of the number of metal beverage containers being produced by a production line (it should be repeated: 2.5 million cans a day). Following this understanding, one must understand the significant logistics present in the distribution and production of metal beverage containers of this type.

However, as set forth above, the same sequence of production of metal beverage containers has necessarily the same print arrangement, that is, the metal beverage containers are virtually identical.

If there is a desire to make metal beverage containers with different print arrangements, it is necessary, in the prior art, to interrupt the production line in order to change the printing plates 3a-3f.

In this regard, the beverage market is greatly influenced by the marketing of the companies of this business segment. Thus, the print arrangements or finished arts on metal beverage containers are considered extremely important to such companies. This is because the consumer is often influenced to buy a given product by the visual aspect brought by the print on the metal beverage containers.

This influence in the decision of the consumer has put more and more pressure on the marketing sectors of the beverage companies, because they require the launching of new and different print arrangements and designs. However, despite the efforts of these sectors, the can manufacturers have significant limitations in the ability to be flexible, namely due to the fact that the same type of metal beverage container produced in the same series (in the production of the can or in the packing of the product) necessarily has always the same finished art. This is not related to the limitation of the professionals involved in the creation of the layout or print arrangement of the metal beverage containers, but to the fact that the same production metal beverage container series without manufacturing interruption will necessarily have the same printed art.

The present invention is provided to solve the problems discussed above and other problems, and to provide advantages and aspects not provided by prior apparatuses of this type. A full discussion of the features and advantages of the present invention is deferred to the following detailed description, which proceeds with reference to the accompanying drawings.

### SUMMARY OF THE INVENTION

The invention in question relates to a can printing apparatus that has a number of ink-cartridges depending on the need for colors to be printed onto the cans. These ink-cartridges supply ink to a number of printing plates that have finished arts that will impart the shapes and colorful print arrangements to the cans.

Such printing plates having finished arts are fixed to respective plate cylinders, so as to communicate with transfer blankets fixed to a transfer blanket drum to supply ink, whereby this ink comes from the ink-cartridges.

Thus, the transfer blankets are, in turn, moved to transfer ink from the ink-cartridges to the cans, each of the transfer blankets having respective finished arts in low relief and free from ink from the ink-holders.

Moreover, it is also an objective of the invention to provide a process for the production of cans that use the above-described printing apparatus. The steps of this process are: (i) supplying ink from the ink-holders to the printing plates present on the respective plate cylinders; (ii) supplying ink from the printing plates to transfer blankets by rotation of the printing plates; (iii) transferring ink from the transfer blankets to the cans; and (iv) forming finished arts of low relief present in the transfer blankets on the cans.

One aspect of the present invention is directed to a dry offset rotary metal beverage container decorator. The decorator comprises a plurality of ink applicators, a plurality of printing plates, and a plurality of transfer blankets. The plurality of printing plates each have a print surface engaging a corresponding ink applicator of the plurality of ink applicators and receives a quantity of fluid therefrom. The plurality of transfer blankets each have an ink receiving surface and wherein each ink receiving surface sequentially engages each print surface of the plurality of printing plates and wherein the ink receiving surface comprises a plurality of blanket relief features comprising a photosensitive emulsion surface.

This aspect of the invention may include one or more of the following features, alone or in any reasonable combination. The plurality of transfer blankets may be rotationally mounted such that each transfer blanket sequentially engages each of the plurality of printing plates to receive a quantity of fluid therefrom. The plurality of blanket relief features may comprise high relief features and low relief features. The high relief features may comprise the photosensitive emulsion surface. The low relief features may be free from the photosensitive emulsion. Each print surface of the plurality of printing plates may comprise printing plate relief features. The printing plate relief features may comprise high and low relief features. The high relief features of the printing plate relief features may deliver ink to the high relief features of the blanket relief features.

Another aspect of the present invention is directed to a dry offset rotary metal beverage container decorator. The decorator comprises a plurality of ink applicators, a plurality of printing plates, and a plurality of transfer blankets. Each printing plate comprises a print surface engaging a corresponding ink applicator of the plurality of ink applicators and receives a quantity of fluid therefrom. Each print surface comprises a printing plate high relief feature, and a printing plate low relief feature. The printing plate high relief feature corresponds to a printing plate image wherein the printing plate high relief feature receives fluid from the corresponding ink applicator. The printing plate low relief feature is free from engagement with the corresponding ink applicator. The transfer blankets are rotationally mounted such that each transfer blanket sequentially engages each of the plurality of printing plates to receive a quantity of fluid therefrom. Each transfer blanket comprises a transfer blanket high relief feature and a transfer blanket low relief feature. The transfer blanket high relief feature comprises a photosensitive emulsion surface. The transfer blanket low relief feature cooperates with the transfer blanket high relief feature to form a transfer blanket image and wherein a first transfer blanket image on a first transfer blanket is different from a second transfer blanket image on a second transfer blanket.

Another aspect of the invention is directed to a method of sequentially and continuously transferring a detailed art to a plurality of metal beverage containers on a dry rotary offset metal beverage container printing apparatus wherein a first metal beverage container in the plurality of metal beverage containers receives a first detailed art and a second metal beverage container processed by the apparatus immediately subsequent to the first metal beverage container receives a second detailed art, the method comprising the steps of: (1) providing a first transfer blanket having relief features formed on an upper surface thereof and rotationally mounted on a dry rotary offset printing apparatus; and (2) engaging a beverage container sidewall with the relief features on the first transfer blanket with sufficient force to impart a shape change in the beverage container sidewall.

This aspect of the present invention may include one or more of the following features and/or steps, alone or in any reasonable combination. The method may further comprise the steps of: (1) providing a plurality of printing plates rotationally mounted on the dry rotary offset printing apparatus, each printing plate having a finished art in high relief, a first printing plate in the plurality of printing plates having a first finished art comprising a high relief portion of the first printing plate comprising a portion of the upper surface of the first printing plate; (2) applying a first quantity of ink to the high relief portion of the first printing plate; (3) engaging the first printing plate with the transfer blanket; (4) rotating the first printing plate against the upper surface of the first transfer blanket; and (5) transferring ink from the high relief portions of the first printing plate to the upper surface of the first transfer blanket prior to engaging the beverage container sidewall with the first transfer blanket. The method may further comprise the step of: (1) providing a second printing plate in the plurality of printing plates having a second finished art in high relief different from the first finished art of the first printing plate; (2) applying a second quantity of ink to the high relief portion of the second printing plate; (3) engaging the second printing plate with the first transfer blanket; (4) rotating the second printing plate against the upper surface of the first transfer blanket; and (5) transferring ink from the high relief portions of the second printing plate to the high relief features of the first transfer blanket prior to engaging the beverage container sidewall with the first transfer blanket. The method may further comprise the steps of: transferring ink from the high relief portions of the first transfer blanket to form a first art on the sidewall of the beverage container simultaneously with engaging the beverage container sidewall with the first transfer blanket with sufficient force to impart a shape change in the beverage container sidewall. The shape change may comprise deboss features. The deboss features may cooperate with the first art on the sidewall of the beverage container to form a complimentary overall design comprising interplay between inked portions of the sidewall and tactile impressions of the sidewall. The apparatuses as described herein may be used to carry out these methods and provide these features.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a view of the printing apparatus of the prior art;

FIG. 2 is a schematic view of a pallet compared with a man of medium height;

FIG. 3 is a perspective view of the printing apparatus of the present invention;

FIG. 4 is a perspective view of internal details of the printing apparatus of the present invention;

FIG. 5 is an enlarged perspective view of internal details of the printing apparatus of the present invention;

FIG. 6 is an enlarged perspective view of internal details of the printing apparatus of the present invention;

FIG. 7 is a perspective view of a set of transfer blankets;

FIG. 8 is a perspective view of a set of printed cans according to the present invention;

FIGS. 9-16 are alternate versions of FIGS. 1-8, respectively;

FIG. 17 is a top and cross-sectional view of a transfer blanket showing zones A, B, and C;

FIG. 18 is a magnified view of zone A from FIG. 17;

FIG. 19 is a magnified view of zone A from FIG. 17;

FIG. 20 is a magnified view of zone A from FIG. 17;

FIG. 21 is a magnified view of zone B from FIG. 17;

FIG. 22 is a magnified view of zone B from FIG. 17;

FIG. 23 is a magnified view of zone B from FIG. 17;

FIG. 24 is a photograph of three sequentially produced cans according to the principles of the present invention; and

FIGS. 25A-D are front views of blankets of the present invention; and

FIG. 26 is a perspective view of an inked printing plate affixed to a plate cylinder wherein substantially an entirety of the inked surface of the printing plate is in high relief;

FIG. 27 is a schematic view of a transfer blanket of the present invention having a photosensitive emulsion surface and a masking layer on portions thereof, both being exposed to a source of ultraviolet light; and

FIG. 28 is a schematic view of the transfer blanket of FIG. 27 subsequent to exposure to the ultraviolet light, rinsing or removal of the unexposed portions of the photosensitive emulsion masked by the masking layer during the exposure to produce transfer blanket high relief and low relief features.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

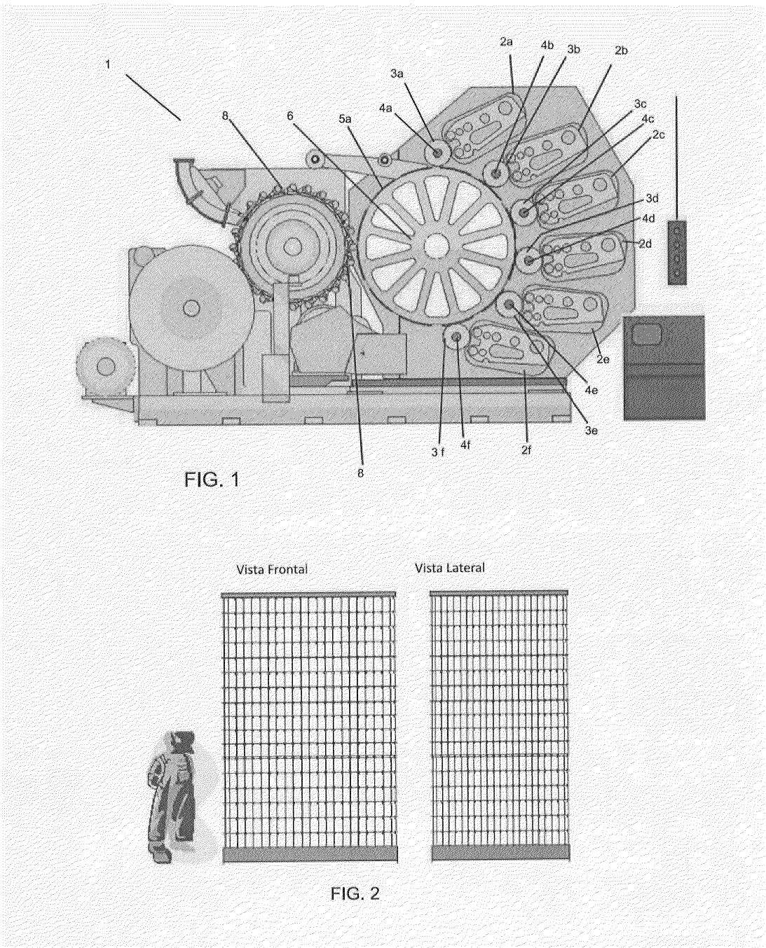

The object of FIG. 1 was described above in the explanation of the prior art. However, it is important to stress that the invention in question is applied to a can printer, that is, a printing apparatus 1. The invention also relates to a modification introduced in such equipment, which enables one to print different finished arts onto cans, this printing takes place without interruption of the production.

In this way, it is possible to obtain, at the end of the can production line, pallets with different finished arts or print arrangements, i.e., instead of having the same sequence of can production with equal prints, it is possible to have cans with different print arrangements, which has a substantially significant commercial effect. This is because it is possible for the same commercial establishment to receive cans containing, for example, the same product, but in cans which are different from each other.

This becomes very important because there is the possibility of a wide range of different creations for the marketing sectors of the companies that produce beverages. Thus, for instance, if there is a determined promotion or festivity of great magnitude, the object of the present invention enables the production of cans from the same production series, i.e. sequentially and continuously manufactured, to have different print arrangements, as for example cartoons, animal drawings, person names, country names, or still of sports activities. In short, the print arrangements or finished arts may be of different kinds and depend basically on the respective creativity of the creator of cans, since in light of the present invention there is no longer any technical limit that requires the interruption of printing to provide cans with different print arrangements or finished arts from the same uninterrupted sequence of production.

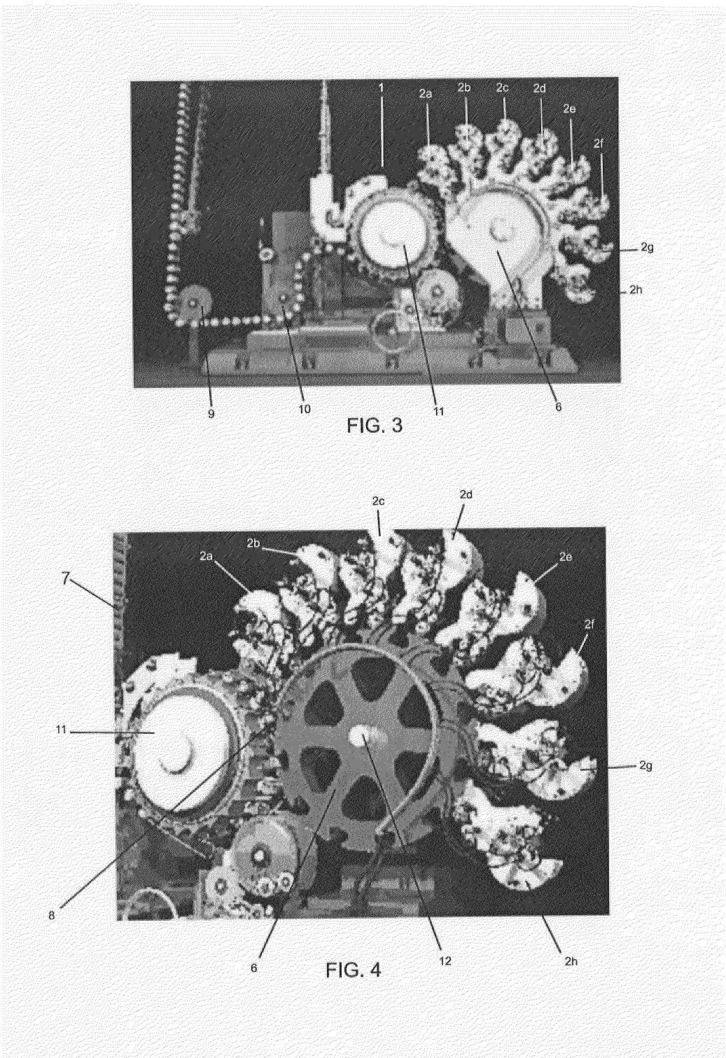

The printing apparatus 1 can be observed in greater detail in FIG. 3, which shows a can chain 7 having a plurality of cans 8 that are fixed to said can chain 7 in a rotatory manner. In the left portion of this FIG. 3, one can see cans 8 that come from the initial production processes, mainly from the mechanical shaping processes. These cans pass through a first directing wheel 9 and then through a second directing wheel 10. In this way, and with the aid of other elements of the equipment, not described or disclosed, it is possible to direct the cans 8 retained in the can chain 7 so that they will be led to the can carrying apparatus or can indexer 11.

On the can indexer 11, the cans are then displaced in a circle around said indexer 11. Although the cans 8 are retained in the can chain 7, they still have the possibility of turning around their main axis, i.e. a central longitudinal axis about which the can is formed.

In the right portion of FIG. 3, one can see eight ink-cartridges 2a-2h, positioned in half-moon arrangement, which follow the same central axle 12. It can be noted that, in this embodiment of the invention, there is a limited number of ink-holders, but it is important to point out that this is a project option, and there may be a larger or smaller number of ink-cartridges 2.

In FIG. 4, which shows the right portion of FIG. 3, one can see in greater detail the inside of the printing apparatus 1. The central axle 12 is, indeed, the transfer blanket drum 6, which has a radial arrangement of the ink-cartridges 2a-2h close to part of its perimeter.

However, the ink-cartridges 2a-2h do not rest on the transfer blanket drum 6, since between each ink cartridge 2a-2h and the transfer blanket drum 6 there are respective plate cylinders 4a-4h. As mentioned above, on the plate cylinders 4a-4h there are respective printing plates 3a-3h that have the finished arts in relief on their outer surface facing the transfer blanket drum 6.

Moreover, the printing plates 3a-3h are responsible for the communication between the ink-cartridges 2a-2h and the transfer blankets 5a-5l, which are placed on the outer surface of the transfer blanket drum 6. Obviously, there should be a positioning/interaction between the printing plates 3a-3h and the transfer blankets 5a-5l, so that the transfer blankets 5a-5l can interact in a precise manner with the cans 8 to be printed.

With a view to exemplify how the interaction between the components responsible for the printing takes place, FIG. 5 shows an internal portion of the printing apparatus 1. For practical purposes, one will demonstrate only the functioning of a part of the transfer of ink for printing, since the process is analogous for each ink-cartridge.

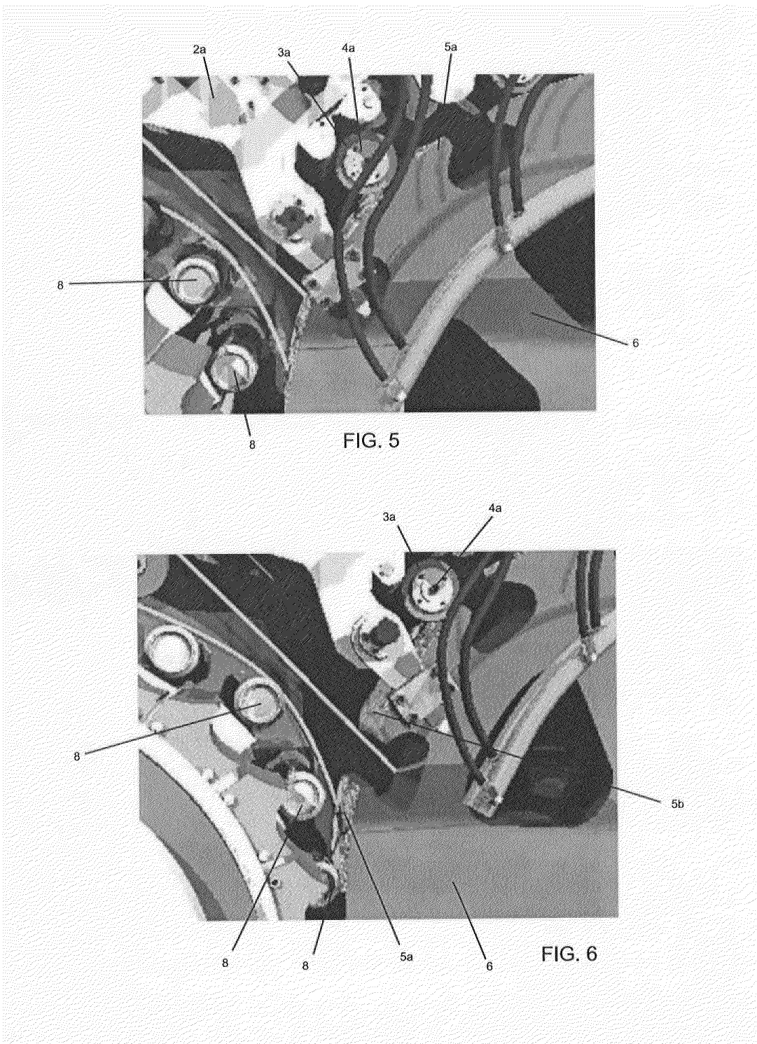

In FIGS. 5 and 6, the process, also an object of the present application, can be better understood, wherein the ink cartridge 2a supplies ink to the printing plate 3a present on the plate cylinder 4a, and ink is transferred chiefly to the high reliefs existing there, which have a finished art or print arrangement.

The plate cylinder 4a, upon coming into synchronized contact by the printing plate 3a with the transfer blankets drum 6, supplies ink from its high relief to the transfer blanket 5a, wherein this takes place by rotation of the printing plate that transfers the ink present on high relief to the transfer blanket 5a.

Afterwards and by opposite directions rotation of the transfer blanket drum 6 and the can indexer 11, the transfer blanket 5a that has the ink from the printing plate 3a transfers the ink present on the transfer blanket 5a to the can 8, which is rotated under some pressure against the transfer blanket 5a.

It is pointed out that, if it is necessary to print more than one finished art or different colors onto the can 8, the transfer blanket 5a will also have passed through the other printing plates 3b-3h present on the respective plate cylinders 4b-4h. The same occurs successively with the other transfer blankets 5b-5l that have the finished art coming from any printing plates that are necessary for obtaining all the finished art of different colors on the cans 8 to be printed.

Thus, the finished arts present on the printing plates are transferred to the transfer blankets, which in turn transfer ink to the cans 8.

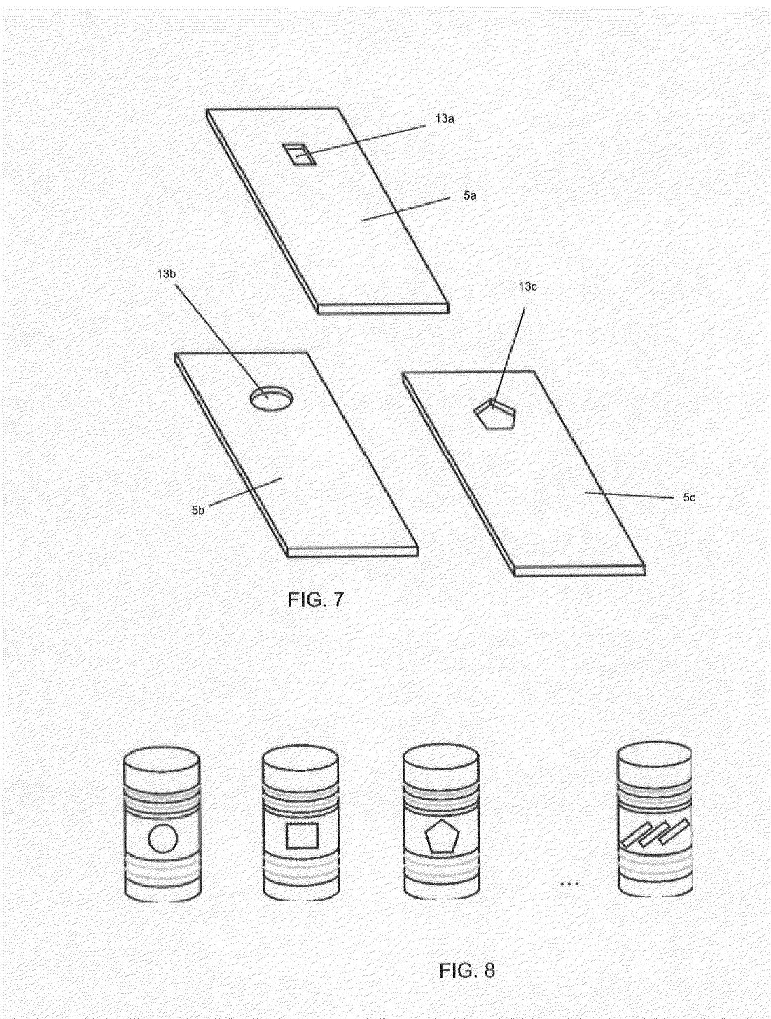

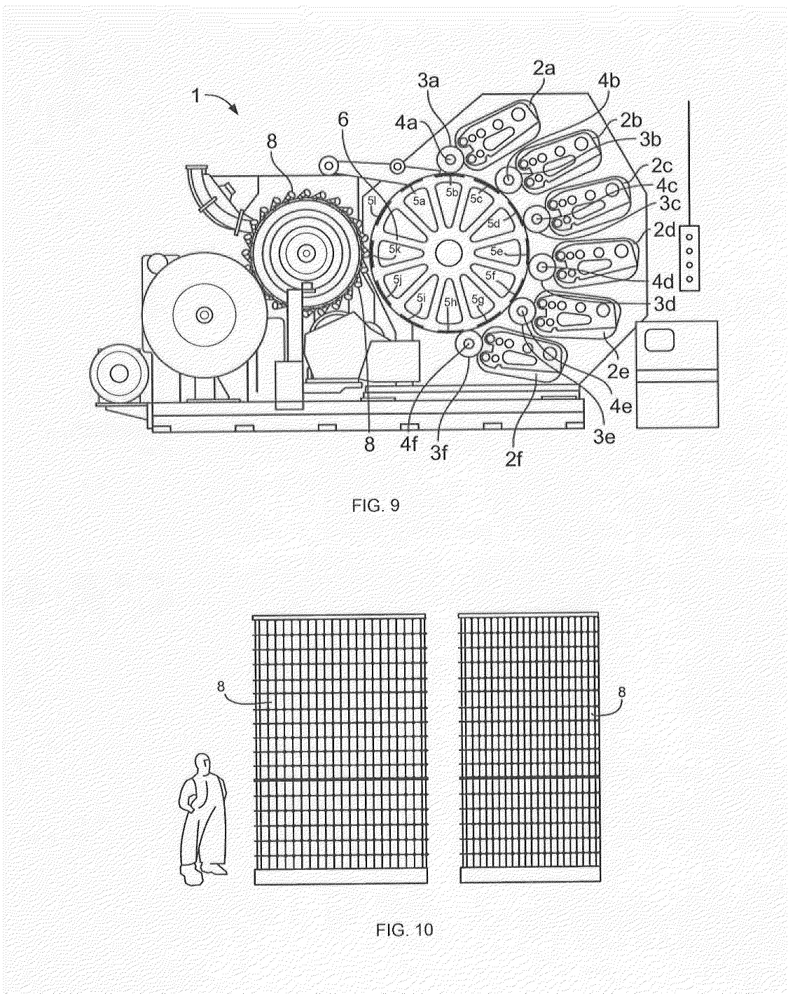

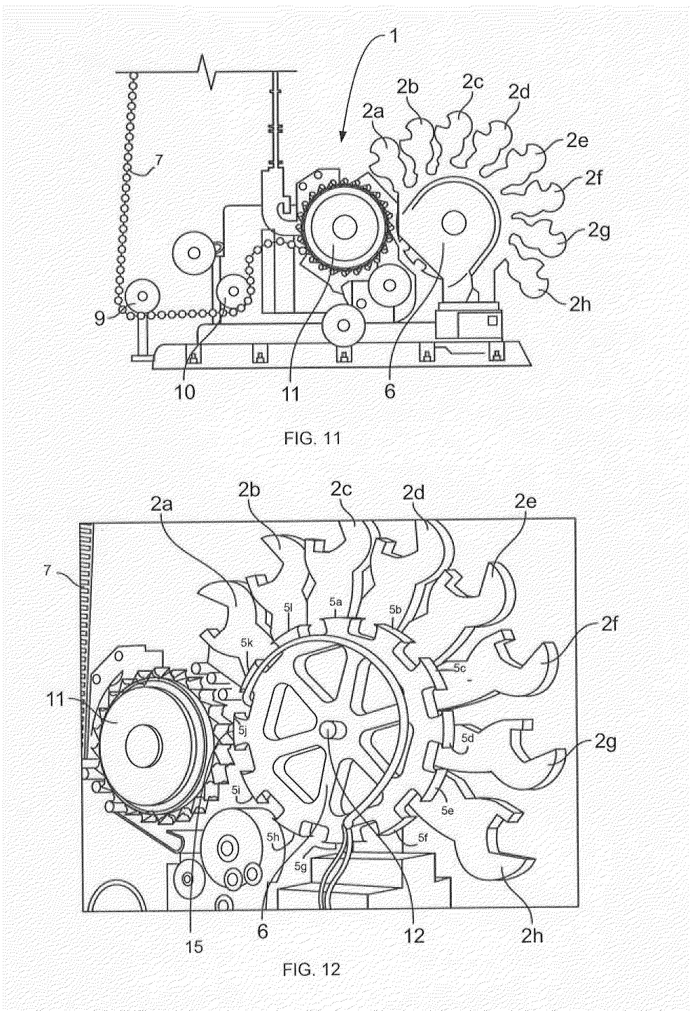

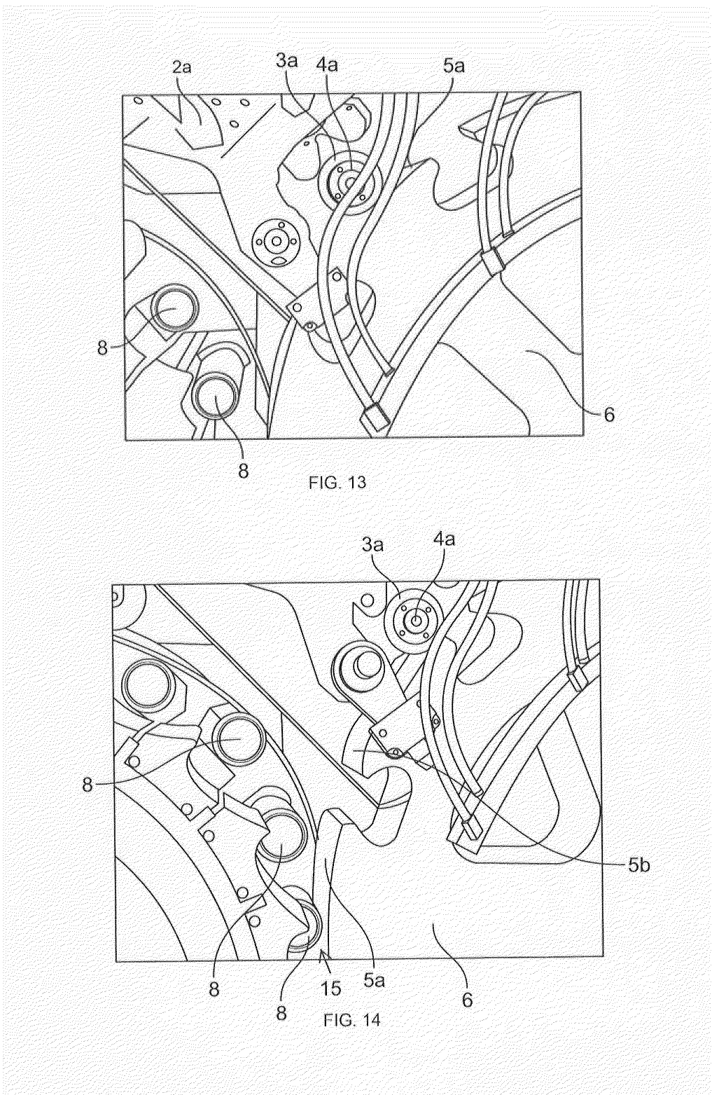

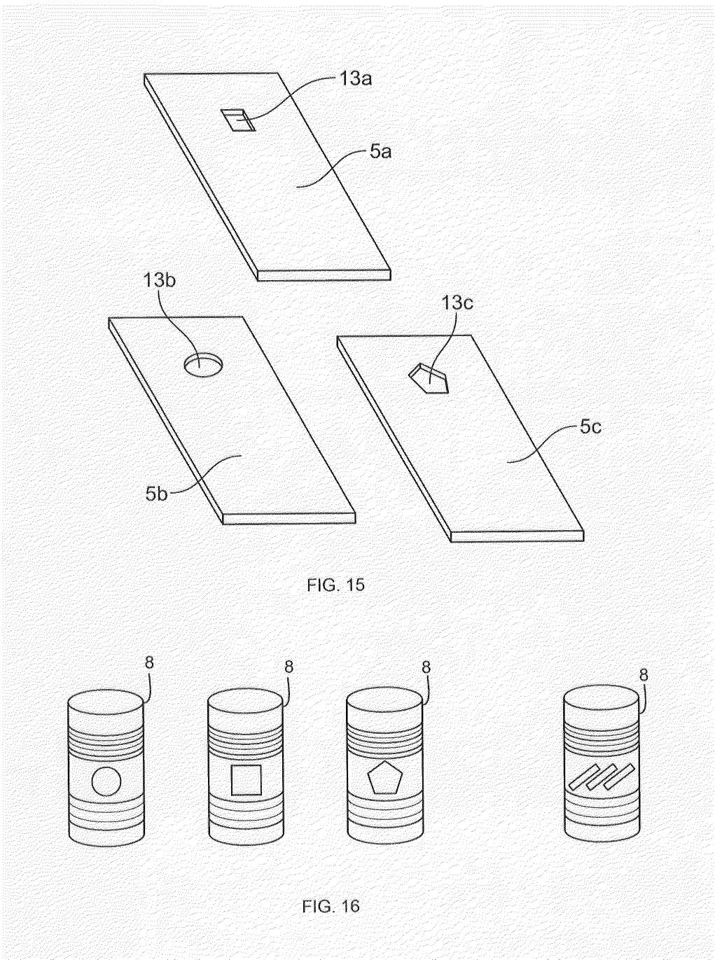

The transfer blankets of the present invention can be seen in FIG. 7.

Usually, that is, in the prior art, these transfer blankets are only smooth surfaces that are used as ink transferring means between the printing plates 3a-3h and the cans 8 to be printed. However, in the present invention the transfer blankets also have the function of being a graphics mean that has influence on the finished arts of the cans 8 to be printed.

In the example of FIG. 7, one demonstrates only three transfer blankets 5a-5c, but there may be several blankets with low relief according to the need for different finished arts on the cans 8. In other words, the number of different finished art or graphs from the blankets on the cans is limited to the number of blankets present on the blanket drum 6.

In the preferred embodiment of the present invention one has opted for using a transfer blanket drum with twelve blankets 5a-5l, but, as mentioned before, only three blankets are shown in FIG. 7.

It is of the utmost importance to note that the transfer blankets 5a-5c have respective low reliefs 13a-13c, wherein the low reliefs of finished arts are in reality low relief 13a-13c with different shapes. Therefore, there is a finished art in low relief 13a present on the blanket 5a, a finished art in low relief 13b present on the blanket 5b and another finished art in low relief 13c present on the blanket 5c.

Thus, when there are three types of blankets 5a-5c with different finished arts in low relief, it is possible that all the finished arts coming from printing plates will be transferred by ink to the transfer blankets 5a-5c, so that the cans 6 will be printed in this way.

However, since each of the finished arts 13a-13c is in low relief, there will be no ink in this low-relief portion of each of the blankets. There will be no contact, in this low-relief region, between the blanket and the cans 8 to be printed. Indeed, the original color of the can 8 will remain in this region free from ink or free from contact between the can 8 and the respective blanket that is transferring the ink from the transferring blankets to the can 8.

Therefore, if there is a low-relief finished art 13a on the blanket 5a which, in the present example, a circle, there will be no print or ink transfer from this low-relief region to the can 8. Therefore, a first finished art is formed on the can 8, as shown in FIG. 8, which is in the form of a circle, for explanation purposes.

Thus, the next can 8 to be printed will also receive ink from the printing plates, but from the next blanket. In this example, the transfer blanket 5a has a low-relief finished art 13b in the form of a rectangle. In this way, the can to be printed will have a second finished art in the form of a rectangle in the original color of the can.

Following the same logic, a third can to be printed will also receive ink from the printing plates, but from a subsequent blanket other than the first two ones. This third transfer blanket 5c has a low-relief finished art 13c in the form of a pentagon, so that the can to be printed will have a third finished art in the form of a pentagon in the original color of the can.

As already mentioned, the number of different finished art on the cans will only be limited to the number of blankets present on the blanket drum 6.

It is further stressed that the finished arts present on the blankets—that are portions of removed material of the blankets—are arranged directly on the blankets without any other type of layer on the blanket, so that the latter can have the printing function, i.e., the function of having a finished art that will be present on the printed can.

It is reiterated that the low reliefs or portions of material removal will represent absence of ink, which will enable one to view the original color of the can, be it the color of the aluminum or of a coating of other coloring that the can to be printed already has.

The finished art produced by the low relief will be a final contour on the printed can, which will provide a clearer finished art, and the low relief present on the blanket will have less problems with usual printing aspects, such as, for instance, ink stains, smears or any other type of problem related to the high-precision printing or detailing.

In FIG. 8, one demonstrates by reticence that there is the possibility of more than three types of finished arts from the printing process and apparatus of the present invention. This is verified through a subsequent can with another finished art in the form of three consecutive lines.

Obviously, the finished arts or graphic arrangements are not limited to geometric shapes, but may be any type of graphic means that one desires to print on the cans 8, as for example, names of persons, of teams, figures, etc. In this regard, the limitation is no longer in the printing process, but rather in the creativity of those who develop the finished arts to be applied to the printed cans.

In the face of the foregoing, it is possible to have, in the same uninterrupted production line, cans with different finished arts, which was possible only with the interruption of the production line until the advent of the present invention.

However, it was not feasible, in terms of logistics, to obtain cans from the same production sequence with different finished arts on the same pallet, or still delivered to the beverage manufacturers, such as supermarkets. However, this has become possible with the present invention.

According to another embodiment of the present invention, artwork with improved resolution and/or increasing complexity can be generated using transfer blankets 5a-5l with improved, highly detailed low-relief features. In the prior art, the printing plates 3a-3h carry detailed art in high relief as described above. The high relief art is transferred to a transfer blanket 5a-5l which then prints the can 8. As described above, the transfer blankets 5a-5l may be supplied with low relief art wherein the can 8 will have an area devoid of ink corresponding to the low relief art on the transfer blankets 5a-5l. By way of example, under a prior art printing process, printing plate 3a-3h will have a relief feature. To print, for example, “BRAND X SODA” on a can, a printing plate 3a-3h has “BRAND X SODA” in high relief a surface of the printing plate 3a-3h. Then the ink is applied to the high relief on the surface of the printing plate in the shape of “BRAND X SODA”.

In the present invention, it is contemplated that improved and more flexible high resolution low-relief features can be generated by treating the transfer blankets 5a-5l with a suitable laser beam. In this embodiment, portions of the blanket 5a-5l are removed by laser treatment. Through laser ablation, very different, highly complex and detailed relief patterns can be created on each of the transfer blankets 5a-5l, rather than simple shapes and the like as discussed above.

For example, each blanket 5a-5l is typically produced from a non-metallic material such as a rubber (or a polymer or composite) rectangle the size of a legal paper. Each blanket is typically ⅛ to ¼inch thick (3.2 mm to 6.4 mm). Shading can be generated by varying the depth and size of the low-relief features. In practice, printed areas on a finished can be made lighter or darker depending on how much of the surface of a particular transfer blanket 5a-5l is removed during the laser treatment process.

Basically, there are two different properties that are essential to the laser treatment discussed herein: tolerance of the cut and surface finish. Standard technology laser cutting equipment that has been in use for 5+ years uses a focused laser beam. The spot size of the laser beam determines the tolerance and the surface finish. Older laser cutting machines that have been in service for 5+ years, have 0.008 to 0.010 inches spot diameter size (0.2 mm to 0.3 mm). Newer laser cutting machines a focus within a spot diameter size of 1-2 thousandths (0.001 to 0.002 inches) of an inch (0.03 mm to 0.05 mm). Generally, using a laser as contemplated by the inventors, a low-relief feature having a surface finish or depth as little as 0.001 inches (0.03 mm) or less can be created.

In creating high resolution low-relief features on a transfer blanket 5a-5l using a laser cutting apparatus, the apparatus must position and move the beam accurately. Because the beam is moving in two dimensions (e.g., an X & Y coordinate system) speed of the laser beam movement must be controlled. For example, if a straight cut is being generated, the laser beam speed across the surface of the transfer blanket needs to be constant. Once a curved cut or low-relief pattern is desired, the speed at which the laser beam travels must be varied so that the laser beam can affect the cut itself. Software and algorithms calculate the proper speed of the laser beam along the surface as cuts are made. Suitable transfer blankets have been manufactured using a 420W Stork® brand laser engraver set at a speed of about 12 m/s The result is a smooth cut and a smooth surface finish.

To avoid a resultant blurring effect on a finished can caused by the low-relief features produced by laser ablation on the transfer blankets 5a-5l, the surface of the transfer blanket 5a-5l must have a better surface finish, especially, or primarily, an edge of the transfer blanket surface between the low-relief laser ablated surface and an untreated surface. The better the edge surface the laser creates, the better the printed edge of the finished product. This better surface finish will result in a cleaner, crisper image.

Final surface finish of a laser treated transfer blanket 5a-5l is dependent on the transfer blanket 5a-5l thickness prior to laser treatment. A thicker transfer blanket will have a rougher final surface finish. The laser does not cut as smoothly in thicker substrates.

However, depending on the algorithm, the speed, and the arc, smoothness of the laser cut can be improved. When a laser is cutting an arc or intricate shapes, the algorithm will change the speed and how the laser beam is moving. This results in a cleaner shape.

In generating transfer blankets of the present invention laser beam spot size was generally on the order of 0.003 inches (0.08 mm). However, such a spot size is inadequate for producing cans with high resolution graphics devoid of ink as contemplated herein. More specifically, the inventors determined that transfer blanket low-relief pattern quality suffers when a laser beam spot size greater than 0.002 inches (0.05 mm) is employed. This will result in a target surface finish of about 125 to 250 micro inches (about 0.002 inches or 0.05 mm).

To illustrate this aspect of the invention, referring to FIGS. 17-23, a transfer blanket 5 is treated with a laser to produce a low-relief rectangle 50. A zone A of FIG. 17 represents a corner 54 of the rectangle on an upper surface of the blanket 5 forming an edge between a laser treated portion of the blanket 5 and an untreated portion of the blanket 5; a zone B represents inside corners 66,68 of the rectangle 50; and a zone C represents a laser treated surface finish upon the rectangle floor.

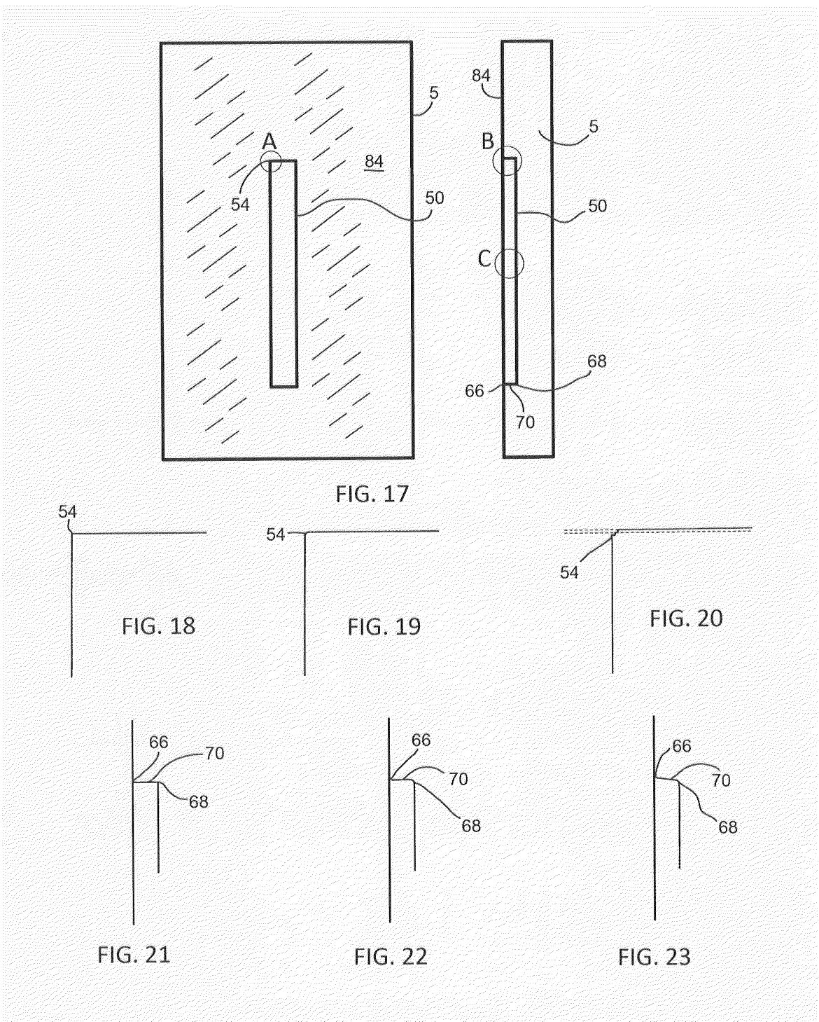

Referring to FIGS. 18-20, in zone A, the corner 54 quality is a function the laser beam design, accuracy of the XY coordinate axis positioning, and the blanket 5 material. As shown in FIG. 18, a sharp 90° corner is difficult to achieve. Generally, the corner exhibits a certain radius of curvature as shown in FIG. 19. Regarding the edge level quality in FIG. 19, the edge quality of the corner 54 is material dependent because projection of the blanket material may take place during laser treatment. Thus, the contour of the cut must be within 2 parallel lines as shown in FIG. 20.

Referring to FIG. 21, in theory, in zone B, sharp angles at the inside corners 66,68 would result from laser ablation forming the rectangle 50. However, as shown in FIG. 22, due to the laser milling process, there will be 2 separate curvatures at the corners 66,68, a first radius of curvature on the edge of the corner 66 forming the contour of the rectangle and a second radius of curvature at the corner 68 forming a bottom of the ablated groove. These radii are specific to the laser process used (laser type, laser parameters, material type). As shown in FIG. 23, a wall 70 between the corners 66,68 is angled between 75° and 105°, typically angled outwardly greater than 90°, more specifically 105°±5°. In practice, substantially 90° angles are formed at the corners when forming a solid image, such as the rectangle 50 shown. When producing micro portions or dots as described below, the wall 70 will generally be angled according to the parameters set forth above.

Further, the corner 66 forming the contour of the rectangle is critical in establishing the high level of graphic quality discussed hereinafter. A surface finish of the transition between an upper surface of a blanket 5 on which ink is deposited by a printing plate 3 (high relief portion) and the recessed portion of the blanket 5 (low relief portion) is less than or equal to 3.5 Rₐ, preferably less than 3.5 Rₐ, and more preferably 3.0 Rₐ±0.1 Rₐ. Additionally, the most preferable surface finish in this region has 3.33 Rₘₐₓ. Adequate blankets have been manufactured having a surface finish of about 3.03 Rₐ.

In zone C, the rectangle floor's surface finish is a function of laser technology and blanket material. A target of 125 to 250 micro inches (about 0.002 inches or 0.05 mm) for the surface finish is preferred to achieve desired results. Suitable blankets having a surface roughness of 3.03 Rₐ (3.33 Rₘₐₓ) have been produced having a floor depth of about 0.015 inches (0.38 mm). It has been determined that the floor depth of about 0.015 inches (0.38 mm) performs well in that ink is not transferred from the low relief floor to the beverage container 8 when the floor is at least 0.015 inches (0.38 mm).

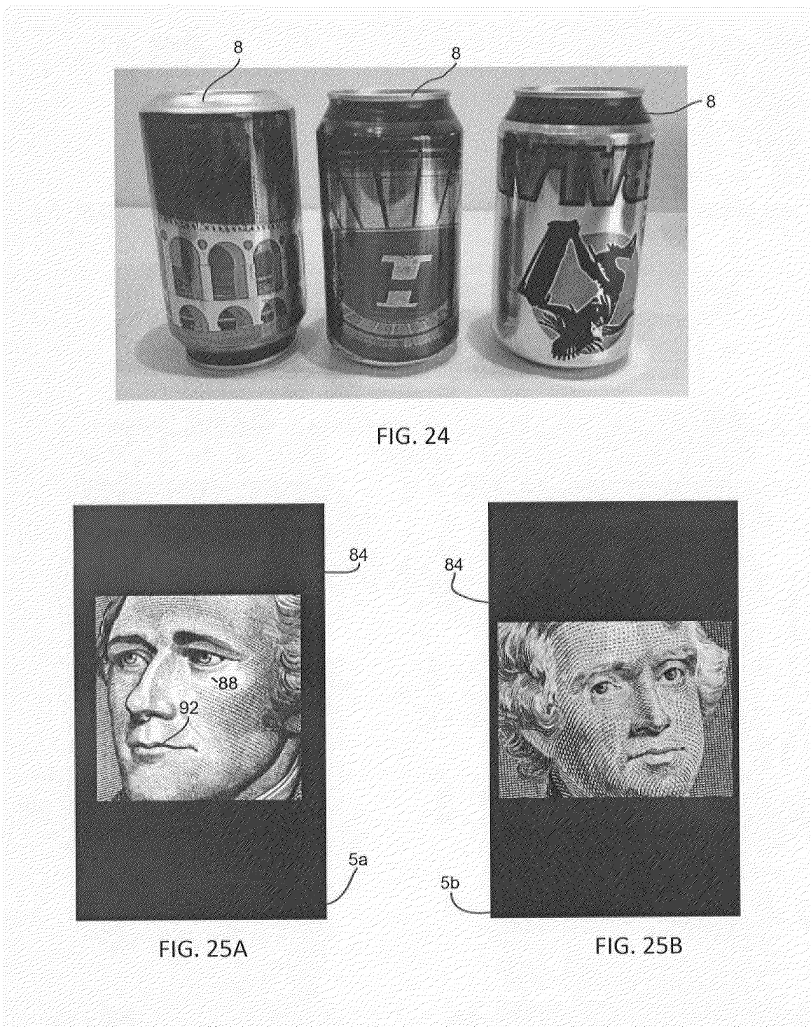

FIG. 24 shows an example of three sequentially produced beverage containers which may be produced having highly detailed unique art, relative to each other. These cans have gray scale art produced with three unique blankets 5a-5c according to the present invention. Note that much of the detail is achieved by way of the natural metallic color of the metallic can produced by low relief features on the blankets 5a-c. In this example, at least one of the printing plates has a relatively large portion of the upper surface in high relief. If the blankets 5a-c were typical blankets used in the art, the cans would have no art other in an area of the can sidewall corresponding to the high relief portion of the printing plate other than an overall black color. In other words, but for the relief art on the blankets 5a-5c, the cans would at least have a very large black portion. However, when blankets 5a-5c according to the present invention are employed having low relief features, the cans exhibit art in a color combination comprising the background color (black) and highly detailed unique art formed by the original color of the can. This is accomplished by the printing plate having substantially a large area of an upper surface in high relief with ink deposited thereon which delivers the ink to high relief portions of the blanket (black). The blanket has highly detailed unique art laser etched thereon in low relief. The beverage container can otherwise have art detail provided by the remaining printing plates. In other words, each metal beverage container produced in sequence up to a finite number of metal beverage containers, typically less than fifteen, will have a first art identical to the other metal beverage containers in the sequence and a second art unique to the individual metal beverage container.

Even more detailed metal beverage container decoration and images can be created by using an interplay between the high and low relief features on the printing plates 3 with the high and low relief features on the transfer blankets 5 together with the colors delivered from the ink cartridges 2. See, for example, FIG. 24.

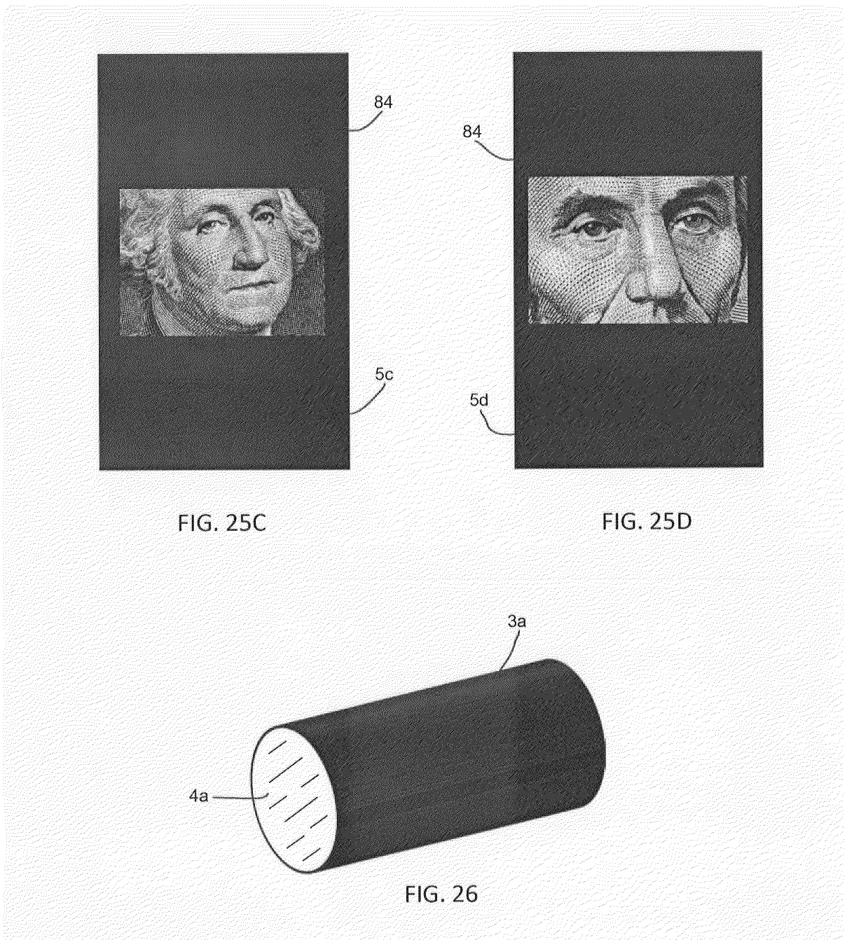

FIGS. 25A-D are front views of blanket 5a-5d of the present invention which illustrate how low relief features produced according to the methods described above can be used to generate highly detailed art when used in combination with printing plates as described above. Here, low relief features can be varied in size and location to produce shading and detail which results in a very complex image. According to further principles of the invention, a plurality of unique blankets can be introduced into a rotary inking apparatus as described above wherein a corresponding plurality of different resultant cans can be produced continuously and sequentially. For example, in the blanket illustrated, a man's face is depicted. In practice, the can printing apparatus may be outfitted with a plurality of blankets 5a-5d, e.g. four, wherein each exhibit unique low relief features, relative to each other, to produce 4 cans sequentially, wherein each of the four cans has a different art thereon, for instance four different men's faces in the example illustrated. It should be noted that the number of different sequentially produced cans is only limited by the number of blankets a particular printing apparatus is capable of using. In the previous example, as few as two and as many as twelve different sequentially produced cans may be produced continuously.

More particularly to FIGS. 25A-D, each blanket 5a-5d has been treated with a laser to remove portions of an upper surface 84 of each blanket 5a-5d. Using a laser having a laser beam spot size less than 0.002 inches (0.05 mm) very precise removal of the blanket material can produce micro high relief and low relief portions 88,92 of the upper surface 84 of the blankets 5a-5d. A black ink has been applied to the upper surface 84 of the blankets 5a-5d. It follows that the high relief features 88 are black in the figures, and the low relief features 92 are a lighter color. The resultant sequentially and continuously printed cans have unique art heretofore unrealized in the can making art.

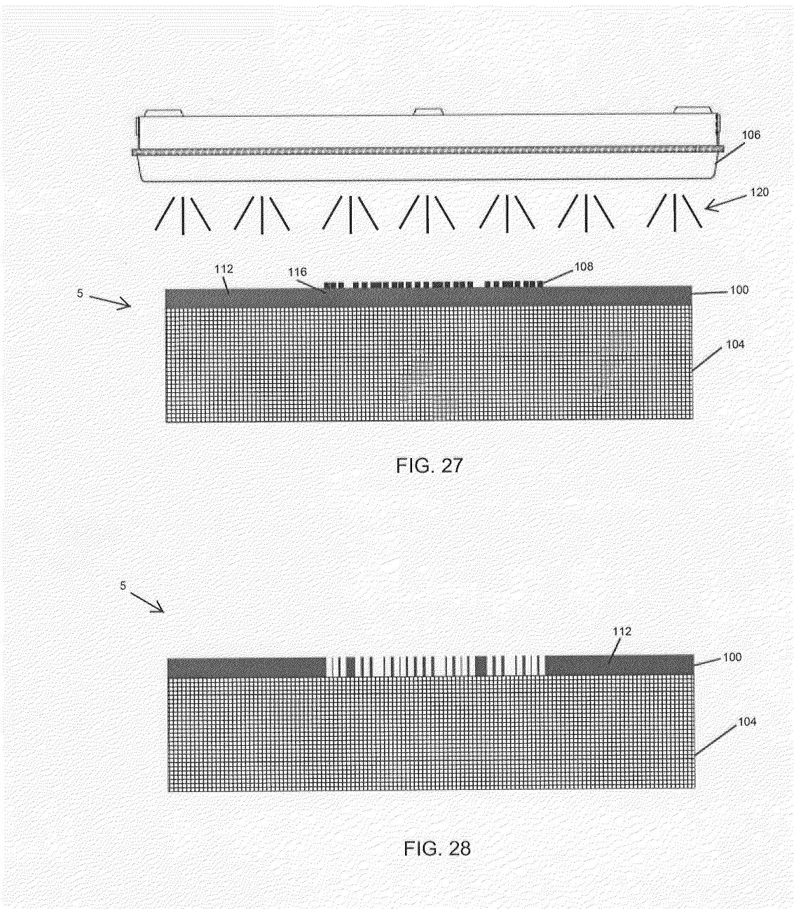

The highly detailed transfer blankets illustrated in FIGS. 25A-D may also be created using a photosensitive emulsion. Referring to FIGS. 27 and 28, a transfer blanket 5 has flowable photosensitive emulsion layer 100 deposited on a suitable substrate 104 to subsequently create a non-flowable photosensitive emulsion surface 108 on the transfer blanket 5 upon or after exposure to a source of energy. When such a flowable emulsion is exposed to an ultraviolet (UV) light source 106, crosslinking occurs. The crosslinking produces a non-flowable surface or skin 108. The part of the emulsion that reacts to the UV light is a sensitizer. For example, two basic types of photosensitive emulsion are generally categorized by sensitizer: diazo, which has been in use for more than twenty years, and the newer styryl basolium quaternary salt photopolymers. These sensitizers are added to a resin base of polyvinyl alcohol or polyvinyl acetate.

An ultra-violet light blocking agent 108 is placed over a portion or portions of the photosensitive emulsion layer 100 to mask or cover the photosensitive emulsion layer 100 in desired locations prior to exposure to the UV light. The blocking agent 108 is deposited in a pattern corresponding to a design art in high relief desired to be exhibited by the transfer blanket 5, such as the art depicted in FIGS. 25A-D. Highly detailed art can be produced by applying the blocking agent with a printer communicating with a computer, such that the printer delivers the blocking agent to the blanket corresponding to images created on or merely transferred from the computer. The blocking agent 108 may be an ink, but regardless of the type of particular agent 108 used, the ultra-violet light blocking agent 108 will be substantially unaffected by exposure to a source of ultra-violet light 106 at least over the duration of a preselected or predetermined exposure time. The UV light source 106 may be a single light source, like a fluorescent ultra-violet light tube, a row of lights, or an array of light, light emitting diodes, CFL bulbs of ultraviolet frequency, multi-spectrum metal halide, fluorescent, and incandescent light sources. The source of ultra-violet light 106 preferably operates or emits light at a wavelength between 360 and 400 nanometers. When exposing the blanket 5 and the flowable photosensitive emulsion layer 100, the desired wavelength will have the effect of substantially solidifying a first region 112 of the layer of the photosensitive emulsion 100 on the blanket 5 while a second region 116 of the layer of the photosensitive emulsion 100 masked by the ultra-violet light locking agent 108 remains substantially flowable.

Thus, for each blanket 5, a desired design (see FIGS. 25A-D) takes the form of a blocking agent layer or layers 108 printed or applied on the photosensitive emulsion layer or layers 100 on a substrate 104. Each emulsion coated transfer blanket 5 is then exposed to the source of ultra-violet light 106. Each exposed blanket 5 is processed by power spraying or by chemical reaction. Rinsing of the blanket 5, thus, may be accomplished with a pressurized fluid subsequent to the exposing step wherein the portion of the ultra-violet light sensitive emulsion layer 112 that was exposed to a light 120 emitted by the source of ultra-violet light 104 remains on the substrate 104 and the portion of the ultra-violet light sensitive emulsion 116 beneath the ultra-violet light blocking agent 108 is removed by the rinsing step. In other words, high relief features on the blanket 5 will correspond to the unmasked portions of the photosensitive emulsion layer 100 on the blanket 5, and low relief features on the blanket 5 will correspond to masked portions of the photosensitive emulsion layer 100 on the blanket 5.

Each blanket 5 is then dried. Once dried, the blanket 5 is ready for use on the dry offset metal beverage container printing machine 1.

According to an embodiment of the invention, a dry offset rotary metal beverage container decorator 1 has a plurality of ink applicators, a plurality of printing plates, and a plurality of rotationally mounted transfer blankets.

Each printing plate has a print surface, typically in high relief, engageable with a corresponding ink applicator of the plurality of ink applicators. The print surfaces receive a quantity of fluid from the ink applicators. It follows that the printing plates may also have features in low relief.

Each transfer blanket has an ink receiving surface, typically in high relief. Each ink receiving surface sequentially engages each print surface of the plurality of printing plates. The ink receiving surface has a plurality of blanket relief features comprising a non-flowable photosensitive emulsion surface (i.e. a non-flowable surface or skin of cross-linked photosensitive emulsion treated with a source of UV light). The transfer blanket may also have features in low relief. The low relief features may be free from the photosensitive emulsion.

In another embodiment, a dry offset rotary metal beverage container decorator has a plurality of ink applicators, a plurality of printing plates, and a plurality of transfer blankets.

The plurality of printing plates each has a print surface engaging a corresponding ink applicator of the plurality of ink applicators and receives a quantity of fluid therefrom. Each print surface has a printing plate high relief feature, and a printing plate low relief feature. The printing plate high relief feature corresponds to a printing plate image, and the printing plate high relief feature receives fluid from the corresponding ink applicator. The printing plate low relief feature is free from engagement with the corresponding ink applicator.

The transfer blankets are rotationally mounted such that each transfer blanket sequentially engages each of the plurality of printing plates to receive a quantity of fluid therefrom. Each transfer blanket comprises a transfer blanket high relief feature and a transfer blanket low relief feature. The transfer blanket high relief feature has a non-flowable photosensitive emulsion surface (i.e. a non-flowable surface, skin, or cross-linked photosensitive emulsion previously exposed to a source of UV light). The transfer blanket low relief features cooperate with the transfer blanket high relief features to form a transfer blanket image and wherein a first transfer blanket image on a first transfer blanket is different from a second transfer blanket image on a second transfer blanket.

It is further contemplated that the images created by the processes and apparatuses discussed herein can be combined with thermochromic inks and/or texturing or tactile designs which includes embossing to the cylindrical sidewall of the metal beverage container.

According to the invention, finished art may be delivered to each container in a sequence of continuously, individually decorated metal beverage containers. Printing plates may be provided to indirectly deliver (via transfer blankets) identical finished art to each metal beverage container in a sequence. Individual transfer blankets may have high and low relief features to deliver unique art to each metal beverage container in the sequence, such that two or more adjacent metal beverage containers in a sequence of decorated metal beverage containers may each exhibit some identical decorations or art (originating from the printing plates) and some unique art (originating from the transfer blankets).

Thus, finished designs can be displayed in an absence of ink (e.g. via low relief features in the blanket). Designs, such as names or other identifiers, can be located within a shape (e.g. a rectangle) having an absence of ink wherein the name or identifier are inked (e.g. via high relief portions on a blanket).

Again, the inventors also contemplate shaping and/or tactile features, such as sidewall bending and embossing, used alone or in conjunction with the arts and designs described herein. Here, compression between the blanket 5 and the sidewall of the beverage container produces shaping and/or tactile features on the cylindrical sidewall of the beverage containers 8 in combination with the ink printed art transferred from the blanket 5 to the beverage container sidewall. In prior art, decorators of this kind such shaping and embossing was not possible using smooth surfaced blankets.

For example, in one embodiment, an apparatus 1 includes an indexer 11. The indexer is rotationally mounted to the apparatus 1 and has a plurality of stations for receiving beverage containers 8 therein. The can indexer 11 rotationally delivers a plurality of beverage containers 8 sequentially and continuously to a printing site 15 where a beverage container 8 engages the first blanket and wherein relative pressure between the first blanket and the beverage container imparts a deboss and/or emboss feature on a sidewall of the beverage container. An ink may be optionally transferred to the beverage container sidewall from the first blanket as well. The can indexer 11 transfers the first can 8 from the printing site 15 while simultaneously transferring a beverage container 8 to the printing site 15 wherein the second can 8 engages the second blanket and receives ink therefrom

The inventors further contemplate sequentially producing metal beverage containers having inked names or identifiers in a first color and metal beverage containers in a second color. In this example, the first color and the second color would be printed on different locations of the sequentially produced metal beverage container (relative to each other).

According to an embodiment of the invention, the apparatuses described above may be used to carry out a method for decorating beverage containers. More specifically, a method of sequentially and continuously transferring detailed art to a plurality of metal beverage containers on a dry rotary offset metal beverage container printing apparatus wherein a first metal beverage container in the plurality of metal beverage containers receives a first detailed art and a second metal beverage container processed by the apparatus immediately subsequent to the first metal beverage container receives a second detailed art includes providing a first transfer blanket and engaging the first transfer blanket with a beverage container sidewall. The first transfer blanket has relief features formed on an upper surface and is rotationally mounted on a dry rotary offset printing apparatus. A sufficient force is used to impart a shape change in the beverage container sidewall. Printing plates as described above are provided to transfer ink from ink cartridges to the first transfer blanket as described above, which, in turn, transfers ink to the beverage container sidewall as described above. The transfer of ink and the shape change may occur simultaneously. Thus, art comprising ink and art comprising of tactile impressions are simultaneously transferred to the beverage container on a dry offset printing machine. The inked art and the tactile impressions form a complimentary overall design comprising interplay between inked portions of the sidewall and tactile impressions of the sidewall, e.g. hair texture and color or facial texture and color from the blankets depicted on FIGS. 25A-25D.

According to an embodiment of the invention and further to the features described above, a can printing apparatus 1 has a plurality of ink cartridges 2a-2h, preferably each of a different color. A plurality of printing plates 3a-3h are rotationally mounted on the apparatus 1, preferably as described above. Each printing plate 3a-3h is in communication with a corresponding ink cartridge of the plurality of ink cartridges 2a-2h and has a finished art in high relief. A first printing plate in the plurality of printing plates 3a-3h has a first finished art comprising a high relief portion of the first printing plate. This high relief portion comprises a portion of an upper surface of the first printing plate and is adapted to receive an ink from one of the plurality of ink cartridges.

The apparatus 1 further has a plurality of transfer blankets 5a-5l. The plurality of transfer blankets 5a-5 are rotationally mounted to the apparatus such that each transfer blanket rotates about a single central hub or axel. A first transfer blanket has a plurality of low relief features and a plurality of high relief features on an upper surface thereof. The plurality of low relief features cooperate with the plurality of high relief features to form a second finished art comprising a first character. The first character includes a shading pattern to simulate depth and contour. A second transfer blanket also has a plurality of low relief features and a plurality of high relief features on an upper surface thereof. This plurality of low relief features cooperates with the plurality of high relief features to form a third finished art comprising a second character. The second character includes a shading pattern to simulate depth and contour which is unique relative to the first character on the first transfer blanket. The high relief features on the first and second transfer blankets are engageable with the first printing plate and receive a supply of ink therefrom.

The apparatus 1 also includes an indexer 11. The indexer is rotationally mounted to the apparatus 1 and has a plurality of stations for receiving beverage containers 8 therein. The indexer 11 rotationally delivers a plurality of beverage containers 8 sequentially and continuously to a printing site 15 where a first beverage container 8 engages the first blanket and receives ink therefrom at the printing site 15. The indexer 11 transfers the first beverage container 8 from the printing site 15 while simultaneously transferring a second beverage container 8 to the printing site 15 wherein the second beverage container 8 engages the second blanket and receives ink therefrom.

According to another embodiment of the invention, a method sequentially and continuously transfers a detailed art to a plurality of metal beverage containers 8 on a dry rotary offset metal beverage container printing apparatus 1. A first metal beverage container 8 in the plurality of metal beverage containers 8 receives a first detailed art and a second metal beverage container processed by the apparatus 1 immediately subsequent to the first metal beverage container 8 receives a second detailed art which is unique relative to the first detailed art.

Low relief features are created on a first non-metallic transfer blanket with a laser having a laser beam spot less than 0.002 inches (0.05 mm) in diameter to remove portions of an upper surface of the first non-metallic transfer blanket in a first pattern. The first transfer blanket also has high relief features comprising non-removed portions of the upper surface. Low relief features are also created on a second non-metallic transfer blanket with the laser to remove portions of an upper surface of the second non-metallic transfer blanket in a second pattern first pattern different from the first pattern. The first and second non-metallic transfer blankets are rotationally mounting on a dry rotary offset printing apparatus.

A plurality of printing plates 3a-3h are provided and rotationally mounted on the dry rotary offset printing apparatus 1. Each printing plate 3a-3h has a finished art in high relief. A first printing plate in the plurality of printing plates 3a-3h has a first finished art comprising a high relief portion of the first printing plate. A second printing plate in the plurality of printing plates has a second finished art in high relief different from the first finished art of the first printing plate.

A first quantity of ink is applied to the high relief portion of the first printing plate. The first printing plate is brought into engagement with the first non-metallic transfer blanket. The first printing plate is rotated against the upper surface of the first non-metallic transfer blanket. Ink is transferred from the high relief portions of the first printing plate to the high relief features of the first non-metallic transfer blanket.

A second quantity of ink is applied to the high relief portion of the second printing plate. The second printing plate is brought into engagement with the first non-metallic transfer blanket. The second printing plate is rotated against the upper surface of the first non-metallic transfer blanket. Ink is transferred from the high relief portions of the second printing plate to the high relief features of the first non-metallic transfer blanket;

A first metal beverage container is brought into engagement with the first non-metallic transfer blanket. Ink is transferred from the high relief portions of the first non-metallic transfer blanket to form a first art to the first beverage container.

A third quantity of ink is applied to the high relief portion of the first printing plate. The first printing plate is brought into engagement with the second non-metallic transfer blanket. The first printing plate is rotated against the upper surface of the second non-metallic transfer blanket. Ink is transferred from the high relief portions of the first printing plate to the high relief features of the second non-metallic transfer blanket.

A fourth quantity of ink is applied to the high relief portion of the second printing plate. The second printing plate is brought into engagement with the second non-metallic transfer blanket. The second printing plate is rotated against the upper surface of the second non-metallic transfer blanket. Ink is transferred from the high relief portions of the second printing plate to the high relief features of the second non-metallic transfer blanket.

A second metal beverage container is brought into engagement with the second non-metallic transfer blanket. Ink is transferred from the high relief portions of the second non-metallic transfer blanket to form a second art to the second metal beverage container. The second art is unique relative to the first art.

A preferred example of embodiment having been described, one should understand that the scope of the present invention embraces other possible variations, being limited only by the contents of the accompanying claims, which include the possible equivalents.

### REFERENCE NUMBERS

1: printing apparatus
2a-2h: ink-holders
3a-3h: printing plates
4a-4h: plate cylinders
5a-5l: transfer blankets
6: transfer blanket drum
7: can chain
8: can
9: first directing wheel
10: first directing wheel
11: can carrying apparatus or beverage container indexer
12: central axle
13a-13c: artwork in low relief
66: an edge portion forming a transition between each of the plurality of low relief features and each of the corresponding high relief features on a transfer blanket
68: an edge portion forming a transition between opposite the edge 66
70: a wall separating the low relief features from the high relief features on a transfer blanket
80: a complex image exhibiting shading
84: an upper surface of a transfer blanket
88: high relief features on a transfer blanket
92: low relief features on a transfer blanket

While the specific embodiments have been illustrated and described, numerous modifications come to mind without significantly departing from the spirit of the invention, and the scope of protection is only limited by the scope of the accompanying Claims.

1. A dry offset rotary metal beverage container decorator comprising:
a plurality of ink applicators;
a plurality of printing plates wherein each printing plate has print surface engaging a corresponding ink applicator of the plurality of ink applicators receiving a quantity of fluid therefrom; and
a plurality of transfer blankets wherein each transfer blanket has an ink receiving surface and wherein each ink receiving surface sequentially engages each print surface of the plurality of printing plates and wherein the ink receiving surface comprises a plurality of blanket relief features comprising a photosensitive emulsion surface.

2. The dry offset rotary metal beverage container decorator of claim 1 wherein the plurality of transfer blankets are rotationally mounted such that each transfer blanket sequentially engages each of the plurality of printing plates to receive a quantify of fluid therefrom.

3. The dry offset rotary metal beverage container decorator of claim 2 wherein the plurality of blanket relief features comprises high relief features and low relief features.

4. The dry offset rotary metal beverage container decorator of claim 3 wherein the high relief features comprise the photosensitive emulsion surface.

5. The dry offset rotary metal beverage container decorator of claim 4 wherein the low relief features are substantially free from the photosensitive emulsion.

6. The dry offset rotary metal beverage container decorator of claim 3 wherein each print surface of the plurality of printing plates comprises printing plate relief features.

7. The dry offset rotary metal beverage container decorator of claim 6 wherein the printing plate relief features comprise high and low relief features.

8. The dry offset rotary metal beverage container decorator of claim 7 wherein the high relief features of the printing plate relief features deliver ink to the high relief features of the blanket relief features.

9. The dry offset rotary metal beverage container decorator of claim 8 wherein the plurality of blanket relief features comprises high relief features and low relief features.

10. A dry offset rotary metal beverage container decorator comprising:
a plurality of ink applicators;
a plurality of printing plates, wherein each printing plate comprises a print surface engaging a corresponding ink applicator of the plurality of ink applicators receiving a quantity of fluid therefrom and wherein each print surface comprises:
a printing plate high relief feature corresponding to printing plate image wherein the printing plate high relief feature receives fluid from the corresponding ink applicator; and
a printing plate low relief feature wherein the printing plate low relief feature is free from engagement with the corresponding ink applicator;
a plurality of transfer blankets rotationally mounted such that each transfer blanket sequentially engages each of the plurality of printing plates to receive a quantity of fluid therefrom, each transfer blanket comprising:
a transfer blanket high relief feature comprising a photosensitive emulsion surface; and
a transfer blanket low relief feature, wherein the transfer blanket high relief and low relief features cooperate to form a transfer blanket image and wherein a first transfer blanket image on a first transfer blanket is different from a second transfer blanket image on a second transfer blanket.

11. A dry offset rotary metal beverage container decorator comprising:
a plurality of ink cartridges;
a plurality of printing plates rotationally mounted on the apparatus, each printing plate in communication with a corresponding ink cartridge of the plurality of ink cartridges and having an art in high relief, a first printing plate in the plurality of printing plates having a first art comprising a high relief portion of the first printing plate comprising a portion of an upper surface of the first printing plate wherein the high relief portion of the first printing plate receives an ink from one of the plurality of ink cartridges;
a plurality of transfer blankets wherein a first transfer blanket has a plurality of low relief features and a plurality of high relief features on an upper surface thereof wherein the plurality of low relief cooperate with the plurality of high relief features to form a second art comprising a first character comprising a shading pattern to simulate depth and contour and a second transfer blanket has a plurality of low relief features and a plurality of high relief features on an upper surface thereof wherein the plurality of low relief features cooperate with the plurality of high relief features to form a third art comprising a second character comprising a shading pattern to simulate depth and contour which is unique relative to the first character on the first transfer blanket and wherein the high relief features on the first and second transfer blankets are engageable with the first printing plate and receive a supply of ink therefrom; and
a beverage container indexer rotationally mounted to the apparatus having a plurality of stations for receiving beverage containers therein, the indexer rotationally delivering a plurality of beverage containers sequentially and continuously to a printing site wherein a first beverage container engages the first blanket and receives ink therefrom at the printing site and wherein the indexer transfers the first beverage container from the printing site while simultaneously transferring a second beverage container to the printing site wherein the second beverage container engages the second blanket and receives ink therefrom.

12. The dry offset rotary metal beverage container decorator of claim 11 wherein an edge portion forming a transition between each of the plurality of low relief features and each of the corresponding high relief features has a radius of curvature.

13. The dry offset rotary metal beverage container decorator of claim 11 wherein the low relief features of the first and second transfer blankets have a surface finish between 125 to 250 micro inches.

14. The dry offset rotary metal beverage container decorator of claim 11 wherein a wall separating the low relief features from the high relief features on each of the first and second transfer blankets angles upwardly from the low relief feature to the high relief feature at an angle grated than 90°.

15. The dry offset rotary metal beverage container decorator of claim 11 wherein the low relief features on the first and second transfer blankets are formed by a laser having a beam spot less than 0.002 inches in diameter.

16. The dry offset rotary metal beverage container decorator of claim 11 wherein a wall separating the low relief features from the high relief features on each of the first and second transfer blankets angles upwardly from the low relief feature to the high relief feature at an angle greater than 90° and edges of the first and second transfer blankets between the wall and the high and low relief features have a radius of curvature.

17. The dry offset rotary metal beverage container decorator of claim 11 wherein the plurality of printing plates comprises a second printing plate in the plurality of printing plates having a fourth art comprising a high relief portion of the second printing plate comprising a portion of an upper surface of the second printing plate wherein the high relief portion of the second printing plate receives an ink from one of the plurality of ink cartridges and the first art is different from the fourth art.

18. The dry offset rotary metal beverage container decorator of claim 11 wherein an edge portion forming a transition between each of the plurality of low relief features and each of the corresponding high relief features has a surface finish less than or equal 3.5 Rₐ.

19. The dry offset rotary metal beverage container decorator of claim 11 wherein an edge portion forming a transition between each of the plurality of low relief features and each of the corresponding high relief features has a surface finish having 3.33 Rₘₐₓ.

20. The dry offset rotary metal beverage container decorator of claim 11 wherein an edge portion forming a transition between each of the plurality of low relief features and each of the corresponding high relief features has a surface finish of 3.0 Rₐ±0.1 Rₐ.

21. The dry offset rotary metal beverage container decorator of claim 11 wherein the low relief features have a depth of at least 0.015 inches (0.38 mm).

22. A method of sequentially and continuously transferring a detailed art to a plurality of metal beverage containers on a dry rotary offset metal beverage container printing apparatus wherein a first metal beverage container in the plurality of metal beverage containers receives a first detailed art and a second metal beverage container processed by the apparatus immediately subsequent to the first metal beverage container receives a second detailed art which is unique relative to the first detailed art, the method comprising the steps of:
creating low relief features on a first non-metallic transfer blanket with a laser having a laser beam spot less than 0.002 inches (0.05 mm) in diameter to remove portions of an upper surface of the first non-metallic transfer blanket in a first pattern wherein the first transfer blanket comprises high relief features comprising non-removed portions of the upper surface;
creating low relief features on a second non-metallic transfer blanket with the laser to remove portions of an upper surface of the second non-metallic transfer blanket in a second pattern first pattern different from the first pattern;
rotationally mounting the first and second non-metallic transfer blankets on a dry rotary offset printing apparatus;
providing a plurality of printing plates rotationally mounted on the dry rotary offset printing apparatus, each printing plate having a finished art in high relief, a first printing plate in the plurality of printing plates having a first finished art comprising a high relief portion of the first printing plate comprising a portion of the upper surface of the first printing plate and a second printing plate in the plurality of printing plates having a second finished art in high relief different from the first finished art of the first printing plate;
applying a first quantity of ink to the high relief portion of the first printing plate;
applying a second quantity of ink to the high relief portion of the second printing plate;
engaging the first printing plate with the first non-metallic transfer blanket;
rotating the first printing plate against the upper surface of the first non-metallic transfer blanket;
transferring ink from the high relief portions of the first printing plate to the high relief features of the first non-metallic transfer blanket;
engaging the second printing plate with the first non-metallic transfer blanket;
rotating the second printing plate against the upper surface of the first non-metallic transfer blanket;
transferring ink from the high relief portions of the second printing plate to the high relief features of the first non-metallic transfer blanket;
engaging a first metal beverage container with the first non-metallic transfer blanket;
transferring ink from the high relief portions of the first non-metallic transfer blanket to form a first art to the first beverage container;
applying a third quantity of ink to the high relief portion of the first printing plate;
applying a fourth quantity of ink to the high relief portion of the second printing plate;
engaging the first printing plate with the second non-metallic transfer blanket;
rotating the first printing plate against the upper surface of the second non-metallic transfer blanket;
transferring ink from the high relief portions of the first printing plate to the high relief features of the second non-metallic transfer blanket;
engaging the second printing plate with the second non-metallic transfer blanket;
rotating the second printing plate against the upper surface of the second non-metallic transfer blanket;
transferring ink from the high relief portions of the second printing plate to the high relief features of the second non-metallic transfer blanket; and
engaging a second metal beverage container with the second non-metallic transfer blanket; and
transferring ink from the high relief portions of the second non-metallic transfer blanket to form a second art to the second metal beverage container wherein the second art is unique relative to the first art.
